(19) United States
(12) Patent Application Publication
(10) Pub. No.: US 2010/0257457 A1
(43) Pub. Date: Oct. 7, 2010

(54) REAL-TIME CONTENT COLLABORATION

(76) Inventor: John A. De Goes, Boulder, CO (US)

Correspondence Address: BOSWELL IP Law, 601 Union Street, SUITE 4200, SEATTLE, WA, 98101-4036, US

(21) Appl. No.: 12/419,926

(22) Filed: Apr. 7, 2009

(51) Int. Cl. G06F 3/00; G06F 15/16; G06F 17/30; G06F 9/46

(52) U.S. Cl. 715/751; 709/206; 719/328; 718/102; 707/E17.055; 707/E17.007

(57) ABSTRACT

A collaborative editing system described allows multiple collaboration participants to create and edit content in real-time and in a way that allows the content to converge to a desirable intermediate state. In addition, the system supports large content teams in which many collaboration participants use the system at the same time. The system distinguishes between real-time collaborative presentation and traditional real-time collaborative editing. Collaborative presentation occurs when the system displays a first collaborator's changes to a second collaborator, without altering the content that the second collaborator is working on. In this way, the second collaborator is aware of the first collaborator's changes, but the changes of other participants do not directly impact the second collaborator's work. The collaborative editing system also separates participants by task so that not all content modifications are shared with all participants.

### BACKGROUND

Collaborating to create documents and other content is recognized as a great way to save time and improve the content of documents. Early collaboration involved a writer that created a document and an editor that reviewed the document and proposed corrections, such as by marking up a paper copy of the document and returning it to the writer. There are many types of collaboration, for example, many architects collaborate on a building design; many engineers collaborate on a car design; legal documents are created by lawyers and legal technicians and reviewed and amended by clients, and so forth. As writing has become electronic, word processors and other applications have added features, such as Microsoft Word's Track Changes feature, that allow a similar type of markup within an electronic document. Collaborative techniques have also developed for particular domains, such as creating software source code. For example, source control systems often provide a technique whereby multiple collaboration participants can work on the same set of source code files by storing a copy at each participant's computer, receiving changes to the file from the participant, and then uploading the changes to a central server where the source control system shares the changes with other participants. When changes made by two participants conflict (e.g., modify the same portion of the same file), then source control systems provide numerous mechanisms for merging the changes into one version of the document, ranging from automated merging to manual merging in which the participant is asked which changes to keep and which changes to discard. Content today can describe many types of information, including textual information, pictures, tables, mathematical formulas and calculations, architectural designs, schematics, computer source code, and any other information content that may be represented in digital form. Each of the above types of collaboration is an example of offline collaboration, where each participant separately modifies a copy of the document.

Real-Time Collaboration involves two or more people editing the same document at the same time. For example, N-Brain's Una IDE application and Coding Monkey's SubEthaEdit application provide environments in which participants can connect over a network and make changes to the same document at the same time. As each participant types new text or modifies existing text, a real-time collaborative environment modifies the file on computers associated with each participant (e.g., by modifying an in memory copy of the file or a hard disk copy in response to a participant invoking a “save” operation). The environment may display each participant's changes in a different text color or using some other visual indication so that each participant is aware of the changes made by each other participant. As one participant types, another participant may notice errors (e.g., typographical or syntactic errors based on the domain of the document) and correct them while the first participant continues creating new content, resulting in highly efficient and low-defect content creation. This type of collaboration may also utilize a central server that stores content and facilitates the real-time collaboration. However, collaboration may also occur in a peer-to-peer topology with individual clients sharing changes with one another.

While real-time collaboration fosters faster creation and improved content, it can also produce an endless cycle of editing where someone is nearly constantly modifying at least one file in a project or other document collection. For many types of content, there is often a reason to converge the content to a particular well-defined intermediate state. For example, for a software product, a developer may want to compile the source code of the software product to produce a build for testing. Suppose many people are maintaining a website over its lifespan, and at some point in time, one person is changing the case of all headers on the site, another person is changing the borders of all boxes containing text, and a third person is revising the wording of the web pages. Each task takes a different amount of time, ranging from hours to days, and when the first person is done, the other two may be part of the way through their work. In addition, when one participant is done, he or she will generally be responsible for a new task. Thus, if these participants are working together in a real-time collaboration environment, the content rarely reaches any good intermediate state suitable for deployment to the public.

In many fields, work is ongoing and continues throughout the life of the project, making it nearly impossible for any good intermediate states to be produced without asking every participant to stop work when they are done with their individual tasks and let everyone else catch up. As noted above, offline collaborative systems (such as source control) do not have this problem, because each participant works on the participant's own task and merges the participant's changes with the changes of other participants in a controlled manner, which allows offline collaboration systems to produce good intermediate states. In a real-time collaboration system in which many users performing any number of tasks are modifying the files on each participant's computer, such intermediate states are rarely, if ever, reached. For example, in the case of source code, a single developer may not be able to ever successfully compile the source code with many other participants making changes that often leave one or more source code files in an uncompilable state.

Another problem with existing systems is scalability. Large content projects may include hundreds or thousands of engineers working on various subsets of the content at the same time. Existing real-time collaboration systems are well suited when two or three collaboration participants want to work together on a single task, but it becomes increasingly inefficient for more than two or three participants to work on a single task. In addition, when participants are using a real-time collaboration system to work on different tasks, then there is no guarantee of reaching any good intermediate states, as discussed previously.

### BRIEF DESCRIPTION OF THE DRAWINGS

FIG. 1 is a block diagram that illustrates components of the collaborative editing system, in one embodiment.

FIG. 2 is a flow diagram that illustrates the processing of the system to display changes from other collaborative participants on a local collaborative participant's display, in one embodiment.

FIG. 3 is a block diagram that illustrates the difference between displayed and stored content for two participants of the collaborative editing system, in one embodiment.

FIG. 4 is a block diagram similar to FIG. 3 that illustrates application of the system to the domain of architectural drawings, in one embodiment.

FIG. 5 is a flow diagram that illustrates the processing of the system to separate participant modifications by current task, in one embodiment.

FIG. 6 is a block diagram that illustrates the results of the join preview operation when one participant attempts to join the editing session of another participant.

FIG. 7 illustrates distance and relatedness of content in the domain of a web site, in one embodiment.

FIG. 8 is a block diagram that illustrates a graphical representation of participants and distance between participants, in one embodiment.

### DETAILED DESCRIPTION

### Overview

A collaborative editing system is described herein that allows multiple collaboration participants to create and edit collaborative content in real-time and in a way that allows an individual participant to control which changes affect that participant's copy of the content so that the participant can cause the content to converge to a defined intermediate state, such as to compile source code content or release web content to the Internet, while still maintaining awareness of other participants' changes. In addition, the system supports large content teams in which many collaboration participants use the system at the same time. For example, one type of collaborative content is source code for a software product. Many engineers, or collaborators, may work on the source code and make changes at the same time. Studies have shown that engineers working together can be many times more effective at producing low-defect source code than engineers working individually. Thus, the system allows engineers to edit source code collaboratively. Although participants of the system want to collaborate, some participants may be working on the same task (or concern) while others are working on different tasks (e.g., fixing a different bug or implementing a new feature). There may be times that the participants working on the same task do not want to be affected by changes from participants working on other tasks, but still want to be aware of what participants working on other tasks are doing. For example, when it is time to compile the software product, the participants would like to compile changes for their current task and not be interrupted by compile or other failures based on the changes of participants working on other tasks. Even on a single participant's computer system, the participant may want to be aware of changes others are making, but isolated from any negative effects (e.g., syntax or other errors) introduced by those changes while the participant finishes a task (e.g., fixing a bug).

In some embodiments, the collaborative editing system distinguishes between real-time collaborative presentation and traditional real-time collaborative editing. Collaborative presentation occurs when the system displays one collaborator's changes to another collaborator, without altering the content that the second collaborator is working on. For example, the second collaborator may see changes that the first collaborator is making to source code in a way that is visually distinguished from the existing content, such as by underlining, color, or other font formatting. However, if the second collaborator compiles the source code, then the system uses the content as it exists without the first collaborator's changes. In this way, the second collaborator is aware of the first collaborator's changes, but the changes of other participants do not directly affect the second collaborator's work. Nevertheless, the second collaborator still benefits from the awareness of the first collaborator's changes. For example, the second collaborator can identify potentially conflicting work that another collaborator is performing, reduce duplication of effort, and so forth. The system can apply to many collaborators, and thus in this and other examples herein where two collaborators are mentioned, those of ordinary skill in the art will recognize the application of the system to potentially many collaborators. Traditional real-time editing systems do not distinguish between the stored and displayed version of content, but rather display the latest stored version of the content, whether the changes come from a local participant or remote collaborative participants. In contrast, the collaborative editing system potentially displays changes (i.e., presentation) in addition to those changes that the system applies to the stored content (i.e., editing/modification). By presenting changes to a participant from other participants, the system allows the participant to be aware of the other participants' changes without being affected by the changes in the form of modifying the content files.

In some embodiments, the collaborative editing system introduces the concept of a current task associated with each collaborator's work. The current task specifies a concern on which one or more participants are working. The current task may be defined by a purpose of the collaborator's work (e.g., fixing a particular defect or adding a particular feature). In general, each collaborator is working on or associated with a particular current task, and thus has heightened interested in other collaborators' changes related to the same task. The system may provide traditional real-time collaborative editing for participants working on the same task while providing real-time collaborative presentation for the changes of participants not working on the same task (even when those participants are modifying the same files as the other participants).

In some embodiments, the collaborative editing system provides a default mode through which participants see (e.g., through real-time collaborative presentation) all changes being made by other participants. The system may also provide the ability for one or more participants to join one or more other participants to convert from a presentation session to an editing session, in which the system merges the changes of the joined participants. Because merging will affect a participant's version of content, the system may provide a join preview mode through which participants can preview the changes that a merge would cause to help participants decide whether they want to join other participants.

The system provides many advantages over existing collaboration tools, including transparency, separation of tasks, scalability, divergence reduction, merge reduction, cross training, change resilience, increased quality, and increased productivity. Transparency allows a participant to be aware of what other participants are working on by displaying the changes that other participants are making in real-time. Using this information, the participant can make good decisions about the participant's own work (e.g., choosing not to take the same part of a document in a conflicting direction, not duplicating work that someone else is already doing, and making one's own work more compatible with what others are doing). The system also reduces divergence. Because participants know what others are doing, this feedback discourages changes that would take content in conflicting directions. The cost of divergence in previous systems can be high, especially in areas like software development where unified architecture reduces the cost of software construction and maintenance. The collaborative editing system also reduces merging. Manual or semi-automated merging wastes time—time lost because of divergence. Transparency keeps divergence limited to a small amount and produces modifications that the system can often merge automatically and quickly during a join operation.

Another benefit provided by the collaborative editing system is cross training. Because participants are able to observe their colleagues (and, if they or management desire, work with them in real-time), automatic knowledge transfer is an ongoing and continuous part of the collaboration process. The system also provides change resilience. The system easily accommodates new participants, because existing participants can directly supervise their work or can pair up with the new participants. Because of this resilience and cross training, the collective group of collaborators is less susceptible to the loss of “key” individuals. In addition, the collaborative editing system encourages increased quality and productivity. With more than one participant that views and participates in the creation of content, participants catch mistakes sooner and at less cost to fix. Because work does not have to stop to converge the state of a project, individuals are more likely to be productive a greater percentage of the time. These and other aspects of the collaborative editing system are described in further detail herein.

### System Components

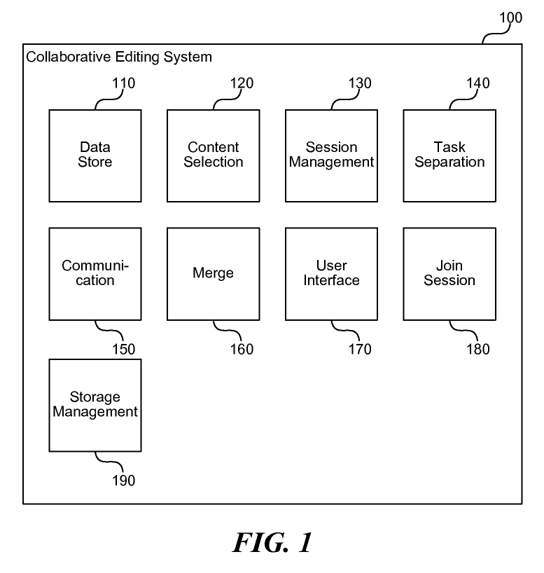

FIG. 1 is a block diagram that illustrates components of the collaborative editing system, in one embodiment. The collaborative editing system 100 includes a data store 110, a content selection component 120, a session management component 130, a task separation component 140, a communication component 150, a merge component 160, a user interface component 170, a join session component 180, and a storage management component 190. Each of these components is described in further detail herein.

The data store 110 stores content that participants can open and edit. The data store 110 may include a database, hard drive, cloud-based storage service, or other hardware for storing data. The data store 110 may include a centralized repository that participants can access through clients attached to a server, or the system may distribute the data store 110, such as to each participant's hard drive, and the system 100 may synchronize data using well-known peer-to-peer synchronization techniques. A particular participant may interact with one data store 110 or many different data stores based on various projects with which the participant is involved.

The content selection component 120 receives a selection from a local participant of content from the data store 110 that the local participant wants to edit. The content selection component 120 may present a user interface for browsing and selecting stored content. For example, the content selection component 120 may provide a tree view or other control for browsing projects and files stored within a content repository. When the participant selects content, the content selection component 120 access the content (e.g., a networked file or database entry) and copies the content to the local participant's computer system so that the participant can edit the content.

The session management component 130 maintains information about an editing session. An editing session includes an identification of one or more participants editing content, identified content the one or more participants are editing, and modifications made to the content by each of the one or more participants. For example, three participants may be editing a document where the first participant has added a paragraph to the document, the second participant has removed a paragraph from the document, and the third participant is spell checking and making corrections throughout the document. The editing session tracks information about the document (e.g., a Uniform Resource Locator (URL) where the document was originally stored), the three participants (e.g., user identifiers or other user information), and the changes each participant has made to the document.

The task separation component 140 manages one or more tasks associated with participants of the system 100. In some embodiments, each editing session managed by the session management component 130 identifies a current task associated with the editing session that specifies at least one purpose of the editing session. For example, several participants may connect to collaborate on fixing a defect identified in a bug database. A text string associated with the editing session, such as “fixing bug #15432,” may describe the focus area. When other participants access the system 100, the participants may be able to view a list of active editing sessions and/or current tasks. For example, if a joining participant notices that another participant is fixing a bug that the joining participant is interested in, then the joining participant may join the editing session. The joining participant may already see changes made to the content related to the current task, and by joining will synchronize the content with the participant's local copy of the content.

The communication component 150 connects computer systems associated with multiple participants that are modifying related content and shares modifications between the computer systems. The communication component 150 may invoke operating system application-programming interfaces (APIs), such as a sockets layer, to communicate via well-known protocols (e.g., Transmission Control Protocol (TCP), Hypertext Transfer Protocol (HTTP), and so on).

The merge component 160 merges changes to related content received via the communication component 150 from multiple participants to create a merged version of the content that includes changes from each participant. For example, if two participants are collaborating to edit a document, and one removes a sentence that the other participant is modifying, the merge component 160 determines which set of changes to accept. The merge component 160 may query the participant to manually merge changes or perform an automated merge in which the system 100 decides which changes to keep. Often changes even to the same document are not conflicting and the system can merge the content by accepting both sets of changes. The merge component 160 may handle multiple types of merging: the real-time merging that generates a single presentation of a document that multiple participants are editing, and the merging that takes place in response to participants joining one another.

In some embodiments, there are three types of merging performed by the merge component 160. The first is a form of real-time merging in order to present a unified view of the presentation to each participant, whether participants are joined or not. The second form of merging, for participants who are joined, reflects any change made by one such participant in both content and presentation for the other joined participants. These processes are not interactive, but rather happen automatically and in real-time. A third type of merging occurs when one user joins another. In this case, the merge component 160 synchronizes the content of the participants' files. Synchronization can take place automatically, but the joining participant can also choose to manually review the merges and modify them as desired, in order to produce unified content that is then used to replace the individual content of each user.

The user interface component 170 displays a view of the merged version of the content to a local participant. The view provides one or more visual indications that distinguish content modified by the local participant from content modified by remote participants as well as distinguishing changes that affect only the presentation from changes that affect both the content and the presentation. For example, the component 170 may display changes from remote participants using a different text color than changes from the local participant. The user interface component 170 may also display separate windows for each participant's changes and may allow the local participant to configure various aspects of the view (e.g., colors used, font style, and so forth).

The join session component 180 adds one or more additional participants to an editing session maintained by the session management component 130. Adding participants may include invoking the merge component 160 to merge modifications from participants already in the editing session with modifications of the added participants to create the merged version of the content. In some embodiments, the system 100 distinguishes whether changes from remote participants modify a stored version of content that the local participant is working on based on whether the remote participants join the editing session of the local participant. For example, the system 100 may display changes to a document that the local participant is working on made by any participant, but only allow those remote participants joined to the session to modify the local participant's stored version of the content. In this way, the local participant can control the amount of modification occurring on the local version of the content (e.g., by rejecting a join request to control who can join the participant's editing session), but still maintain awareness of what other participants are working on. In some embodiments, the system provides a one-way join in which changes from one participant to another occur in only one direction. This can be useful for a situation where one participant wants to be continuously updated on another participant's progress, but the other participant does not want to be interrupted by the joining participant's changes.

The storage management component 190 persists changes to the data store from the local participant and from remote participants joined to the editing session and excludes changes from remote participants not joined to the editing session. Thus, changes from remote participants not joined to the editing session affect the display of the content through the user interface component but not the stored version of the content. The storage management component 190 may invoke operating system APIs to communicate with local storage devices (a hard drive) or remote storage devices (e.g., a database, network drive, or cloud-based storage service).

The computing device on which the system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

### System Processes

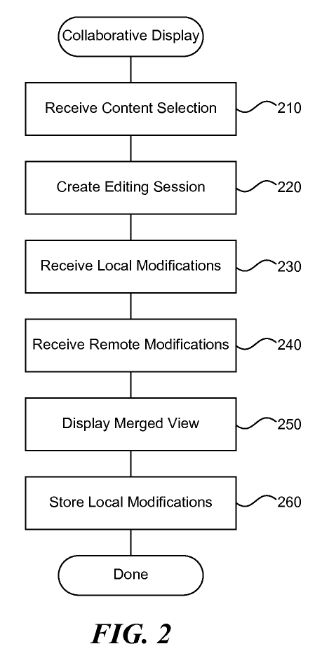

FIG. 2 is a flow diagram that illustrates the processing of the system to display changes from other collaborative participants on a local collaborative participant's display, in one embodiment. In block 210, the system receives a selection of content to edit from the local participant. For example, the system may be associated with a repository of content, such as a document database, website, or other data store. The system may display a dialog box or other user interface for the participant to select content that the participant wants to edit. Content may include an individual file or groups of files, such as in a project. In some embodiments, the system defines an authoring context in which participants work in. The context defines the content (e.g. project, URL, version control repository, collection of files, and so on) that a participant or team of participants are working and collaborating on. Continuing in block 220, the system creates an editing session for editing the selected content. For example, the system may create data structures for storing modifications to the content from the local participant and others, a list of participants associated with (e.g., currently modifying) the content, and other metadata associated with the content. The system also creates a user interface associated with the editing session for displaying the content. For participants editing the selected content after the first participant, selecting content may include joining an existing editing session created for another participant. First the joining participant chooses (or is given) an authoring context and then can see who else is working on the context, how far away from the participant they are located (described further herein), what they are working on, and so forth. The participant can then make a decision whether to continue editing individually or join an existing context. Continuing in block 230, the system receives from the local participant one or more local modifications that alter the content. For example, if the content is a text document, then the local modifications may include adding or removing a paragraph, changing formatting (e.g., italicizing text), and so forth. The user interface provided by the system can include a WYS|WYG or other common editing environment. For example, some editing environments provide domain-specific features, such as syntactic highlighting often provided in programming environments or a grid display commonly used for displaying spreadsheets.

Continuing in block 240, the system receives remote modifications from one or more other participants editing the same content. For example, the other participants may include participants that previously found and joined the editing session of the local participant. Continuing in block 250, the system displays the local and remote modifications in the user interface in real-time so that the local participant can view a merged view of the local modifications and remote modifications as the system receives the modifications. The system may distinguish the modifications made locally from those received from remote participants. For example, the system may display remote modifications in a grayed out or faded font so that the local participant can visually distinguish the local participant's own changes to the content from changes of other participants. Participants can also distinguish changes that affect the content of a document from changes that affect only the document's presentation. For example, if two participants have joined one another, then the system may display the changes of each using one background text color (e.g., the same as a color associated with the joined participant), whereas if the participants are not joined the system displays the text using another background color or a grayed effect.

Note that in this case, the merging differs from traditional source control merging in which the changes of one user can overwrite the changes of another user. In this case, the merged view is a cumulative view of the changes of each participant, and can show what some have deleted, others have added, and so forth. If one participant deletes a paragraph, another participant sees the paragraph as deleted (e.g., with a strikethrough font style), but can still insert text into the paragraph. Similarly, if a participant moves a function to another file, another participant can see the function in both the function's original location and in the new file. In both locations the system may display the function as moved (e.g., colored green). If the second participant tried to move the function again, then the system may display a conflict or provide an indication of a second move. The system preserves information instead of throwing the information away (e.g., creating a single winning version), as with traditional merging.

Continuing in block 260, the system stores the local participant modifications in a persistent data store associated with the local participant without storing at least some of the remote modifications, so that the remote modifications affect the user interface without affecting a persistent version of the content associated with the local participant. The system may distinguish between remote participants that have joined the editing session or are working on the same task as the local participant from participants that are separately working on the same content (e.g., for another task). The system may persistently store changes made by participants joined to the same editing session or sharing the same task but not persist changes received from other participants. After block 260, these steps conclude.

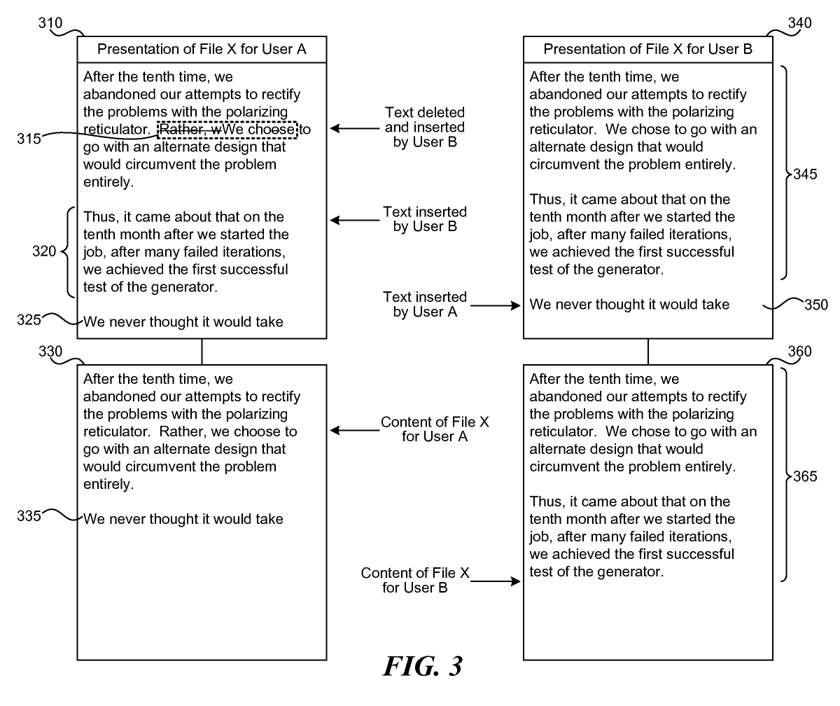

FIG. 3 is a block diagram that illustrates the difference between displayed and stored content for two participants of the collaborative editing system, in one embodiment. The displayed view 310 illustrates the content that the system presents to User A. The content includes deletions 315 and insertions 320 from User B as well as an insertion 325 from User A. The block 330 represents the content stored on a storage device associated with User A. The stored content includes the insertion 335 from User A, but none of the insertions or deletions from User B. Thus, although User A can see the changes made by User B, the stored content of User A is not affected by the changes, and User A can produce a stored, intermediate version of the content without interference from User B or any other participant. Similarly, the displayed view 340 illustrates the content that the system presents to User B. The content includes User B's changes 345 as well as User A's changes 350. The block 360 represents the content stored on a storage device associated with User B (note that the storage devices of User A and User B may be the same storage device or even a central repository where the content versions of users A and B are separately identifiable). The stored content of User B includes User B's changes 365, but not User A's changes.

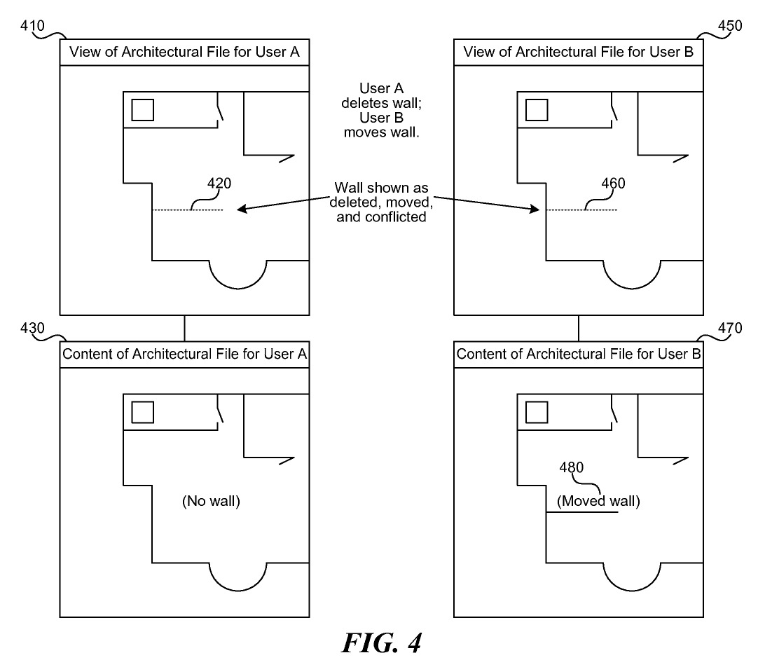

FIG. 4 is a block diagram similar to FIG. 3 that illustrates application of the system to the domain of architectural drawings, in one embodiment. The diagram includes a displayed view 410 presented to User A and a displayed view 150 presented to User B. The views are the same, and each sees a merged set of modifications 420 and 460 made to an architectural drawing by both participants. However, the stored version 430 of the drawing associated with User A contains only User A's modifications (e.g., the deletion of a wall), and the stored version 470 contains only User B's modifications (e.g., the moved wall 480).

FIGS. 3 and 4 illustrate the difference between presenting content to participants and the content stored by the system on behalf of each participant. Although the figures show two participants, the system may include many participants. In addition, the system may merge the changes of some participants (such as those working on the same task as described further herein) so that the changes of some participants affect both the stored and displayed versions of the content while the changes of other participants (e.g., those working on a different task) affect only the displayed version.

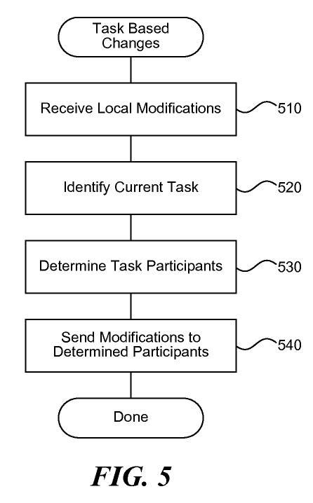

FIG. 5 is a flow diagram that illustrates the processing of the system to separate participant modifications by task, in one embodiment. In block 510, the system receives from a local participant modifications to content associated with a project. For example, the participant may be actively editing one or more files that belong to the project in an editing application. Continuing in block 520, the system identifies a current task of the local participant, wherein the current task describes at least one purpose of the received modifications. For example, the local participant may have provided information about the participant's purpose when he started editing the content, or the system may infer the focus of the participant's changes automatically based on the content or how the participant opened the content (e.g., by browsing an issue tracking database).

Continuing in block 530, the system determines one or more other participants associated with the same task. For example, other participants may have joined an editing session of the local participant. Continuing in block 540, the system sends the local participant's modifications to one or more computer systems associated with the determined one or more other participants associated with the same task. After block 540, these steps conclude.

In some embodiments, the collaborative editing system provides a join function through which one participant can join an editing session of another participant (or group of participants). When the participant joins the editing session, the system merges the changes that each participant has made into a common session, so that changes no longer affect only the presentation of the content, but also the stored version of the content on each participant's computer. The system may perform the merge automatically (automatic merging) or provide an option to allow the joining participant to manually merge the separate changes into a unified set of documents. In the event that two participants take some part of a file in different, conflicting directions, the system invokes a resolution function to resolve the conflict and deterministically decide which operation prevails. For example, if a first participant deletes a paragraph while a second inserts a new sentence into the deleted paragraph. The resolution function would decide the prevailing operation. Resolution functions are common in merging and may include strategies such as most recent wins, displaying a dialog box to a participant requesting a manual resolution, and so forth.

The system may also provide a join preview that allows a participant to see the changes that would occur to the content if the participant joins another participant or group of participants. For example, the system may show text in a strikethrough font that joining would delete and text in an underlined font that joining would add. For example, the participants in the editing session may have made conflicting changes that the joining participant does not want to accept, or the joining participant may want to make certain changes to his local version of the content before joining the editing session, based on conflicting changes or other incompatibilities observed through the preview. The join preview mode modifies the presentation of files to denote the decisions of the resolution function.

For example, if a first participant deletes a paragraph of a text file, and a second participant inserts a new sentence into the same paragraph, and the resolution function determines that the delete of the first participant prevails, then in the join preview mode the first participant would not see the paragraph that he or she deleted, while the second participant would see the entire paragraph (including the sentence inserted by the participant) presented as deleted. The second participant can thus see that if she chooses to join the first participant, the inserted sentence will be lost if the participant allows automatic merging to take place. The join preview mode only affects the presentation of files, and even in the join preview mode, participants are free to continue editing files in the normal fashion. In some embodiments, if a participant attempts to edit information reflected only in the presentation of a file (e.g., edit or delete work added by some participant who the local participant has not joined), the system prompts the local participant to join the originating participant of the content in an editing session.

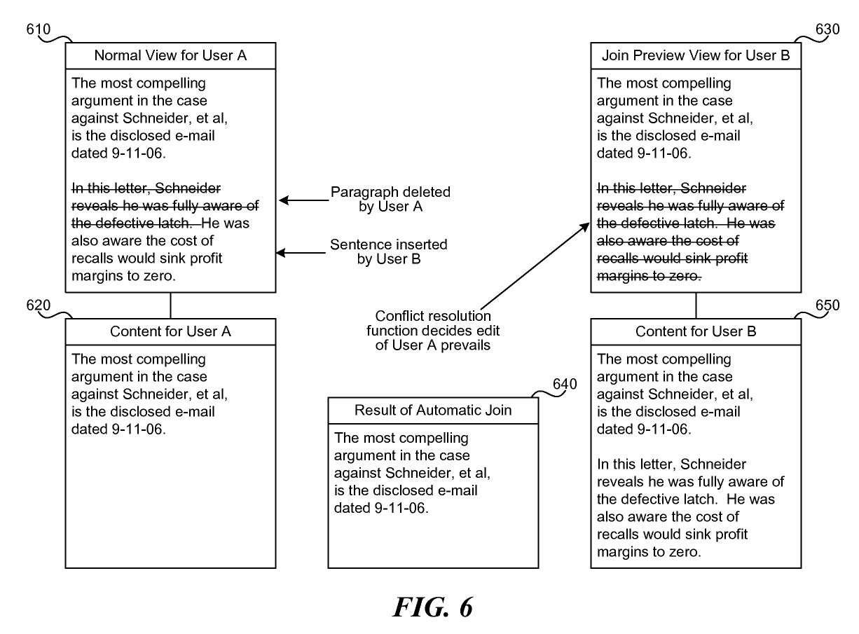

FIG. 6 is a block diagram that illustrates the results of the join preview operation when one participants attempts to join the editing session of another participant. FIG. 6 is based on the example of the previous paragraph. A displayed view 610 illustrates the content the system presents to User A. The displayed view 610 includes changes made by User A and User B. A stored version 620 of the content for User A contains the changes made by User A, but not those made by User B. A displayed view 630 illustrates the content the system presents to User B when User B performs a join preview with User A. As shown in block 640, the automatic conflict resolution of the system determines that User A's changes win even though User A and User B have made conflicting changes to the content. Thus, the displayed view 630 illustrates removal of the paragraph deleted by User A. A stored version 650 contains only User B's changes. However, if User B continues with the join based on the preview, then the system will modify the stored version 650 to match the automatically merged version in block 640.

In some embodiments, the collaborative editing system stores and displays a goal or purpose associated with each editing session so that participants can view the goal to determine whether to join a particular editing session. For example, a participant may create an editing session for fixing a particular bug identified by a number in a bug-tracking database. Thus, the goal of the editing session may indicate, for example, “fixing bug #12345.” Alternatively or additionally, the system may integrate with the bug-tracking database or other tools to display sessions related to items tracked by those tools. Other participants interested in the same bug may join the editing session to contribute to the solution. In some embodiments, the collaborative editing system designates groups of collaboration participants sharing a common goal and editing session as a team. The system may allow one team to join another team or a team to join a participant's editing session as a group.

In some embodiments, the collaborative editing system provides a module with an API that software developers can integrate with a variety of existing content creation applications to add real-time editing functionality. For example, the system may provide an API through which a developer can add the system to Microsoft Word or another word processor to allow participants to collaboratively edit documents. The module provides the work for determining how to merge participant changes, and uses the content creation application to display the merged changes.

In some embodiments, the collaborative editing system determines a distance between participants that is related to the closeness of the content that each participant is working on. For example, the system may determine that two participants working on files in the same directory of a storage device are closer than participants working on files in different directories are. As another example, the system may determine that a participant working on an HTML file of a web page is closer in distance to a participant working on a CSS file associated with the same web page than another participant working on a separate HTML file of another web page.

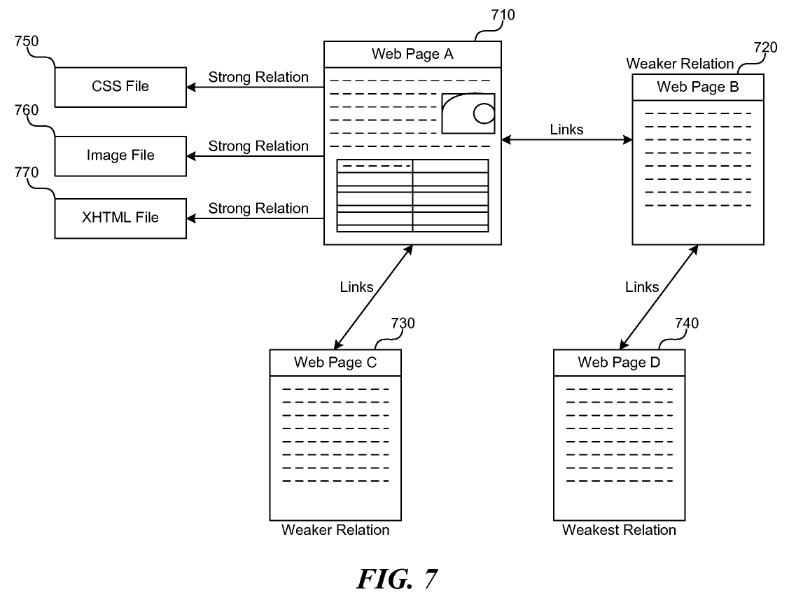

FIG. 7 illustrates distance and relatedness of content in the domain of a web site, in one embodiment. A web site typically includes many web pages, such as web pages 710, 720, 730, and 740. The web pages may contain links to each other as well as to external resources and web pages (e.g., web pages of other web sites). The system may determine a distance or level of relatedness between the pages in a variety of ways, such as by the quantity of links between the pages, similarity of keywords on the pages, and so forth. Each web page includes one or more files that provide the content of the web page, such as a CSS file 750, an image file 760 (e.g., GIF, PNG, and JPG images), and an XHTML file 770. The system may determine the distance of files associated with the same web page to be less than the distance of files associated with different web pages. Thus, if some participants are editing files associated with the same web page and other participants are editing files associated with different web pages or even different web sites, the system can use the determined distance to, for example, determine which other participants' changes to show a particular participant. The distance function is mainly used to allow people who might want to talk or work together to easily find each other, based on the assumption that if two participants are working in related files, then they are more likely to want to talk or collaborate than if they are working in completely unrelated files.

In some embodiments, the collaborative editing system connects computer systems used by multiple participants to edit content using a peer-to-peer networking topology. For example, a computer system of a first participant may connect directly to the computer system of a second participant by specifying an address or other identifying information (e.g., a domain name or other network name) for reaching the second participant. In addition, the collaborative editing system may provide a server for helping participants find other participants working on similar content. However, the participants may still connect using a peer-to-peer connection between each other's computer systems, where the server provides the address used to connect. Those of ordinary skill in the art will recognize numerous common network topologies for sharing information between two computer systems in addition to those described herein as well as certain advantages of various connection types. For example, a server directly connected to the Internet or remote from two client computer systems may allow the client computer systems to connect to each other through a Network Address Translator (NAT) or other address sharing system. In addition, the server may allow the clients to determine information for connecting, such as open ports allowed through a firewall between the two client systems.

Although font differences have been described herein as one way to present content modifications by various participants to another participant, there are many ways that the collaborative editing system can foster collaboration. For example, the system may display each participant's changes in a separate window that contains a copy of the content. The system may also display a local participant's changes in one window and each other participant's changes in another window. The system may also use different colors for each participant's changes, different fonts, highlighting, background colors, and so forth to distinguish changes made by the local participant from changes made by other participants. In addition, the system may distinguish those changes that are being presented to the local participant (but are not committed to the stored content) from those changes that modify the stored content and are merged with the local participant's changes.

In some embodiments, the collaborative editing system allows a participant to hide changes from all or selected other participants. For example, a participant may hide changes from participants that are not working on the same task or from all other participants. When the local participant elects to hide changes from other participants, the system does not show what the other participants are doing. From the local participant's perspective, it is as if he or she is the sole content editor. The local participant may show hidden changes again at any time, bringing the display back to one of the previously described modes of operation.

### Collaborative Tools

In some embodiments, the collaborative editing system provides additional tools for fostering collaboration among participants. For example, the system may provide chat or instant messaging tools, an electronic whiteboard, presence information about other participants (e.g., location and/or status), and so forth.

In some embodiments, the collaborative editing system provides integrated versioning to encourage participants to be creative without fear of permanently losing data. The system provides a participant with separate undo and redo functions, so that participants may undo and redo the changes they themselves have made to a file. Participants may also revert the document back to prior versions or alternate histories of the document, even prior versions or alternate histories created days, weeks, or months beforehand. When a participant reaches a “good state” of one or more files or other content, the participant may mark the state of the files as good. For example, the participant may mark the files by exporting the files, by committing them to a central repository of digital information content, or by tagging them with metadata identifying the state of the files as being good. The system also provides this information to other participants so that they can work on marked versions of the content.

In some embodiments, the collaborative editing system provides an audit trail of changes made by participants to content over the content's lifespan. This enables participants to determine why a participant made a particular change by identifying and asking the participant who made the change. In some embodiments, a participant can ascertain who was the last to change some particular piece of content by use of a keystroke or input device gesture.

In some embodiments, the collaborative editing system integrates changes made to content with tools outside of the system. The system may detect changes to files, for example, by a third-party software application. The system treats external changes as if the participant making the changes made the changes within the system. For example, if a participant makes a change to an image file using Adobe Photoshop or other image manipulation program, the system detects the change, and treats the change as if the participant made the change within the system. Thus, the change is visible to other participants of the system (assuming those members are not hiding changes).

In some embodiments, the collaborative editing system provides a graphical representation of participants. The graphical representation may include a list or tree of the other participants who are in, for example, the same team, with each participant identified by textual name, picture, video feed, or some combination of these. For each participant, participants can obtain information on what the participant is doing, such as an active file set of the participant, or what issue or assignment the participant is working on, and can perform a set of actions associated with that participant—for example, joining the participant.

In addition, the system may provide a graphical representation of participants for a given context, together with a graphical representation of the distance between participants. For example, the system represents participants who are working on strongly related files graphically as being close to each other, while the system represents participants who are working on weakly related files as being far from each other. In some embodiments, the system represents participants as points, icons, images, or video feeds, with accompanying identifying text, and represents the distance as physical distance on the computer display. The system dynamically and continuously arranges the representations so that the distance between representations reflects the distance between the participants. A participant may freely pan or adjust the zoom of the rendering, to see the complete participant space. Teams may be located in a single position, their team members being located a distance of zero away from each other. Zooming into a participant shows zero or more of the following: a representation of the issue the participant is working on, a representation of the active file set of the participant, a representation of the whiteboard canvas of the participant, a representation of the conversations the participant is having, and representations of other information pertinent to the participant's workflow. These representations can help inform a participant as to whether or not to join another participant or team of participants. One participant can join another participant (or team) through a drag and drop input device gesture, such as by dragging the participant's own representation onto the representation of the target participant to join. Similarly, a team may join another team or participant by dragging and dropping the team's representation to the target team or participant.

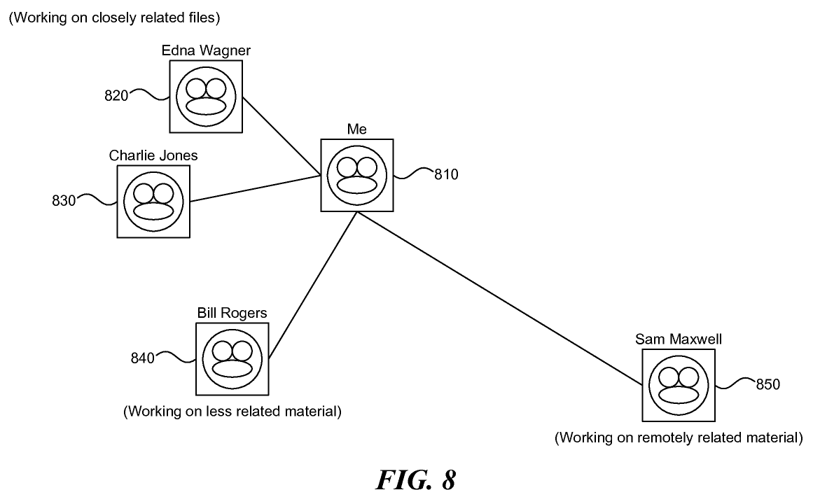

FIG. 8 is a block diagram that illustrates a graphical representation of participants and distance between participants, in one embodiment. The graphical representation 810 represents a current participant viewing a map of other participants. The diagram includes two participants 820 and 830 that are working on closely related content, such as the same files. The system displays participants 820 and 830 closer to the current participant 810. The diagram also includes another participant 840 that is working on less closely related content, such as another file in the same directory as the current participant 810. Finally, the diagram includes a participant 850 working on remotely related or unrelated content. The system displays participant 850 much further from the current participant 810 than other participants. In this way, the current participant 810 can visually determine which participants are working on something similar, and can initiate additional collaboration with those participants, such as by joining an editing session of the participants or sending them a message.

In some embodiments, the collaborative editing system provides an integrated messaging component that facilitates real-time collaboration between participants. A participant determines whether to participate in only conversations by those participants who are viewing or editing closely related content, or more broadly, to include only marginally relevant conversation by participants who are viewing or editing dissimilar content. Typically, a participant at least observes and participates in conversations with fellow team members. The messaging component can include a text, audio, or video chat system, or some combination of these. With a graphical user interface control, keystroke, or input device gesture, the participant can adjust the scope of participants for which the participant is included in conversations. The default scope allows the participant to observe and participate in conversation by participants who are viewing or editing one or more of the same files from among the participant's own active file set. However, the participant may adjust the scope to observe other conversations by participants who are viewing or editing files that are not as closely related to the participant's own active file set.

The user-interface indicates to the participant the relevancy of conversations. For example, the system may play less relevant audio conversations at a lower volume, give less relevant textual conversations a different appearance and/or location, and give less relevant video conversations lower volume, a lower visual weight or a different appearance and/or location. Conversations that a participant is observing but not participating in (e.g., because the target participant or team has selected a lower scope, such that they cannot reciprocate the observation), have a specially denoted graphical representation, so that it is clear to the participant that the target participant or team will not be able to reply to any questions or comments that the participant initiates. If one team member changes the scope for observation, then the system may change the scope for all team members so that each team member observes and participates in the same stream of conversation.

The messaging component also provides a means of private participant-to-participant, participant-to-team, team-to-participant, and team-to-team communication for those circumstances where the default method of communication is insufficient. In some embodiments, the system persists communications so that may search prior communications. This may be helpful, for example, to discover the reasoning behind a particular change to the content.

In some embodiments, the collaborative editing system provides an integrated question and answer component to facilitate non-real-time or delayed collaboration and collaboration between loosely related groups of participants. The system can also provide a graphical presentation of questions and an interface for participants to answer the questions. When a participant in a team asks a question, any participant in the team may reply to the question, which causes the system to alert the participant who asked the question that a reply is available. When a participant asks a question, the system captures the participant's active file set at the time and uses this information to determine the presentation of the question to other participants in a participant-dependent manner. In particular, the system presents questions to a participant in such a way that questions whose captured active file set is closely related to the participant's own active file set (as determined by a total distance function) are given strong visual weight (for example, placed at the top of a list), compared to questions whose captured active file set is only weakly related to the participant's own active file set. Participants are more likely to ask questions related to something they are doing at the time, than to ask completely random questions. Questions and answers are persistent, and in some embodiments, participants may search prior questions and answers.

In some embodiments, the collaborative editing system provides an integrated whiteboard that the system synchronizes with participants. The whiteboard includes a displayed canvas, onto which the system places individual canvases of each participant. The system dynamically and continuously arranges the participant canvases to reflect the distance between the participants. Each team has a single canvas, representing the merged canvas space of the team members. Using panning and zooming, a participant may explore the canvases of other participants who are not joined to the participant. The participant can use user interface controls, such as through a keystroke, button, or mouse gesture to quickly view a region of the canvas that other participants are viewing or editing. The system allows the participant to adjust the zoom based on a specified distance, so a participant may see only those canvases which are related as much or more than the specified distance value (e.g., using a total distance function). In some embodiments, the system persists the whiteboard data, and participants may review prior data.

In some embodiments, the collaborative editing system provides facilities for participants to share files, configuration data, and other bits of digital information. For example, a participant can share a relevant file that exists outside the context of the system-managed content (perhaps outside of any context—a file that is private to the participant), or the participant can share configuration settings, plug-ins, or extensions to the system with other participants. In some embodiments, the participant shares such data by drag and drop input device gesture dragging from the item to be shared to the participant or team to share with, or by invoking a keystroke or clicking on a button that represents the act of sharing. The system may also provide a per-participant drop box into which the participant may place relevant media. Any participant may retrieve a copy of any file that is located in the drop box of any other participant. Drop boxes are useful for storing reference material that comes from an external source, will not be edited, and may be only transiently useful. For example, a participant might keep client specifications or a contract in his drop box for as long as he is performing work for that client.

In some embodiments, the collaborative editing system tracks issues that participants are working on or integrates with existing issue tracking software (e.g., a bug-tracking database). For each participant, the system provides a list of outstanding issues that the participant is responsible for, by default sorted using a priority scheme. The participant may indicate which of these issues the participant is working on by selecting an issue (e.g., by keystroke or mouse). The system may also track an amount of time spent by the participant working on the issue. The system also provides a facility for creating and editing issues. When one participant joins a second participant, the system may assume that both participants are working on the issue of the joined participant. If one team member changes the active issue, the system changes the active issue for each member of the same team. A team has access to all issues that any team member has access to, by default sorted with a composite priority scheme. The system may read issue-tracking data from and write issue-tracking data to a data source/data sink configured by a participant. For example, the data source/sink can include a database of an existing issue management tool, such as Rally, VersionOne, Trac, Bugzilla, Jira, and so forth.

### Conclusion

From the foregoing, it will be appreciated that specific embodiments of the collaborative editing system have been described herein for purposes of illustration, but that various modifications may be made without deviating from the spirit and scope of the invention. As noted herein, the techniques described herein can be applied to many types of content and in new or existing editing environments through the modular nature of the collaborative editing system. Accordingly, the invention is not limited except as by the appended claims.

I/We claim:

1. A computer-implemented method for collaboratively editing content, the method comprising:
receiving from a first user a selection of content to edit;
creating an editing session for editing the selected content;
receiving from the first user one or more first user modifications that modify the content;
receiving from a second user editing the same content one or more second user modifications;
displaying the second user modifications in a user interface in real-time to the first user so that the first user can view a merged view of the first user modifications and second user modifications as the first and second user modifications are received; and
storing the first user modifications in a persistent data store associated with the first user without storing the second user modifications, so that the second user modifications affect the user interface of the first user without affecting a persistent version of the content associated with the first user,
wherein the preceding steps are performed by at least one processor.

2. The method of claim 1 wherein the first user and second user are associated with a current task that indicates that the first user modifications and second user modifications are related.

3. The method of claim 1 wherein displaying the second user modifications but not storing the second user modifications allows the first user to bring the content to a known intermediate state while maintaining awareness of the second user modifications.

4. The method of claim 1 wherein displaying the merged view comprises displaying the second user modifications with a visual indication that distinguishes the second user modifications from the first user modifications, wherein the visual indication is of a type selected from the group consisting of: a separate window, a different font style, a text highlight, a font color, and a background color.

5. The method of claim 1 further comprising, receiving a request from the first user to hide the second user modifications, and in response to the request, removing the second user modifications from the displayed merged view.

6. The method of claim 1 further comprising tracking a version identifier for each of the first user modifications and second user modifications and displaying to the user a user interface control for undoing and redoing one or more selected modifications.

7. A computer system for collaborative editing of content by multiple users, the system comprising:
a processor and memory configured to execute software instructions;
a data store configured to store content that each of the users can open and edit;
a content selection component configured to receive a selection from a local user of content from the data store that the local user wants to edit;
a session management component configured to maintain information about an editing session, wherein an editing session includes an identification of one or more users editing content, identified content the one or more users are editing, and modifications made to the content by each of the one or more users;
a communication component configured to connect computer systems associated with multiple users that are modifying related content and to share modifications between the computer systems;
a merge component configured to merge changes to related content received via the communication component from multiple users to create a merged version of the content that includes changes from multiple users;
a user interface component configure to display a view of the merged version of the content to a user, wherein the view provides one or more visual indications that distinguish content modified by the local user from content modified by remote users;
a join session component configured to add one or more additional users to an editing session maintained by the session component, wherein adding users comprises invoking the merge component to merge modifications from users already in the session with users added to the session to create the merged version of the content; and
a storage management component configured to persist to the data store changes from the local user and from remote users joined to the editing session but exclude changes from remote users not joined to the editing session, so that changes from remote users not joined to the editing session affect the display of the content through the user interface component but not a stored version of the content.

8. The system of claim 7 further comprising a task separation component configured to manage one or more tasks associated with users of the system.

9. The system of claim 7 wherein the editing session identifies a current task associated with the editing session that specifies at least one purpose of the editing session.

10. The system of claim 7 wherein the join session component is further configured to allow a user to preview the modifications that the merge component would make to the content if the user joined the editing session.

11. The system of claim 7 where the system provides an Application Programming Interface (API) through which applications can invoke the system and display the content with merged modifications from multiple users.

12. The system of claim 7 wherein the communication component connects computer systems using peer-to-peer networking so that content and modifications shared between multiple users without a central server.

13. The system of claim 7 wherein the merge component is further configured to detect changes made to the content by applications external to the system, to merge the changes with the content, and to identify the changes with the user that invoked the external application.

14. The system of claim 7 further comprising a messaging component configured to exchange messages between users of the system, wherein the messaging component provides an indication of the relevance of each message based on a determined distance between a sender and a receiver of the message.

15. A computer-readable storage medium comprising instructions for controlling a computer system to provide a collaborative editing environment for multiple users associated with a project, wherein the instructions, when executed, cause a processor to perform actions comprising:
receiving at the computer system modifications to content associated with the project;
identifying a current task of a user of the computer system, wherein the current task describes at least one purpose of the received modifications;
determining one or more other users associated with the same task; and
sending the modifications to one or more computer systems associated with the determined one or more other users associated with the same task, wherein the computer system does not send the modifications to users associated with the project that are not associated with the current task.

16. The medium of claim 15 further comprising tracking the user associated with the modifications and storing an audit trail that identifies the user and the modifications.

17. The medium of claim 15 further comprising determining a distance between each of the users of the collaborative editing environment to each other, and displaying a graphical representation of each user, wherein the layout of the graphical representations is determined by the determined distance.

18. The medium of claim 15 further comprising displaying a control for viewing stored questions and answers related to the current task to the users associated with the current task.

19. The medium of claim 15 further comprising displaying a shared whiteboard to users associated with the current task.

20. The medium of claim 15 further comprising receiving an issue identifier from an issue tracking application, and wherein the current task is associated with the received issue identifier.
